(19) United States
(12) Patent Application Publication
(10) Pub. No.: US 2015/0233181 A1
(43) Pub. Date: Aug. 20, 2015

(54) RELEASABLE COUPLING FOR LADDER SECTION AND THE LIKE

(71) Applicant: Branach Technology Pty Ltd, Boronia, Victoria (AU)

(72) Inventor: Michael Walsh, Boronia (AU)

(21) Appl. No.: 14/426,250

(22) PCT Filed: Sep. 5, 2013
(86) PCT No.: PCT/AU2013/001012

§ 371 Date: Mar. 5, 2015

(30) Foreign Application Priority Data
Sep. 5, 2012 (AU) 2012903864

(51) Int. Cl. E06C 7/50; E06C 1/383

(52) U.S. Cl. CPC E06C 7/50; E06C 1/383

(57) ABSTRACT

A coupling (1) for joining together two sections of a ladder or the like, said coupling comprising a female socket (2) and a male spigot (3) adapted for fitting to said respective sections to be joined with the co-operation of said socket and said spigot effecting said joint wherein said socket includes a socket housing (4) having an internal dock (5) for receiving said spigot said dock including at least one tapered side, said tapered side including a negative step (6) forming a keeper and wherein said spigot includes a spigot body (7) having a tapered reference portion (8) adapted to snugly engage said tapered dock and a section engaging portion (9) protruding therefrom and one or a plurality of jaws (10) pivoted to said spigot body said jaw or jaws including a protruding lug adapted to co-operate with said keeper and a biasing means adapted to expand open said jaws against said tapered dock.

### INTRODUCTION TO INVENTION

This invention relates to the joining together of structures of the type including ladders, walkways, scaffolding, cantilevered platforms etc, where a joining system for such load bearing tools and construction elements must provide a high level of security, safety and rigidity, coupled with an intuitive system of engagement and release.

### BACKGROUND TO INVENTION

The provision of versatility in ladders, walkways, light scaffolding and the like sees a continuous endeavour to provide lightweight, highly durable and safe componentry with ever increasing demands for the size and performance of such systems.

One avenue of providing versatility in such systems is to provide component parts that can be joined together on site thereby allowing a number of smaller component parts be built up into an assembled high performance apparatus.

To date, such joining systems suffer a number of drawbacks including lack of appropriate strength commensurate with the component parts, difficulty in assembling or disassembling, inability to provide snug, rigid snap-fitting type components to include sufficient strength, durability and confidence in use, plus the ability of current systems to allow ready disassembly for packaging and transport.

On object of the invention is to provide an improved coupling system for ladders and the like.

### STATEMENT OF INVENTION

In a first aspect the invention provides a coupling for joining together two sections of a ladder or the like, said coupling comprising a female socket and a male spigot adapted for fitting to said respective sections to be joined with the cooperation of said socket and said spigot effecting said join wherein said socket includes a socket housing having an internal tapered dock for receiving said spigot said dock including a negative step forming a keeper on each side; said spigot including a spigot body having a tapered referencing portion adapted to snugly engage said tapered dock and a section engaging portion protruding therefrom and one or a plurality of jaws pivoted to said spigot body said jaw or jaws including a protruding lug adapted to co-operate with said keeper and a biasing means adapted to expand said jaw or jaws against said tapered dock.

In another aspect the invention provides a coupling for joining together two sections of a ladder or the like, said coupling comprising a female socket and a male spigot adapted for fitting to said respective sections to be joined with the co-operation with said socket and said spigot effecting said joint wherein said socket includes a socket housing having an internal dock for receiving said spigot, said dock including at least one tapered side, said tapered side including a negative step forming a keeper and wherein said spigot includes a spigot body having a tapered reference portion adapted to snugly engage said tapered dock and a section engaging portion protruding therefrom and one or a plurality of jaws pivoted to said spigot body said jaw or jaws including a protruding lug adapted to co-operate with said keeper and a biasing means adapted to expand or open said jaws against said tapered dock.

The protruding lug preferably includes an angled face configured to bear upon the negative step to bias said tapered reference portion of said spigot into snug contiguous engagement with said internal dock of the female socket.

The dock preferably includes two symmetric tapered dock sides with each dock side including a negative step.

The tapered reference portion of the spigot body preferably includes symmetric tapered spigot sides. The spigot preferably includes a jaw operator having a jaw closing taper toward a first end, a jaw opening taper toward a second end and a jaw locking face wherein said jaw operator is adapted for movement between a first position with said jaw closing taper acting on said jaws to close same and withdraw said jaws into said spigot body and a second position with said jaw opening taper acting on said jaws to open or expand same so as to project said lug outside said spigot body and said jaw locking face acting on said jaws to lock same in said open or expanded position.

The jaw operator preferably includes a biasing means biasing the said jaw operator to said second position.

The jaws preferably include a leading taper adapted to co-operate with the jaw opening taper of said jaw operator.

The male spigot section engaging portion preferably includes an indexed collar.

The indexed collar preferably includes a plurality of peripheral index steps.

The index steps preferably include apertures.

The coupling most preferably includes an index locking plate to co-operate with said index collar.

In another embodiment the coupling of the invention most preferably includes a pair of male spigots co-operating with a single common indexed locking plate to provide an articulated joint for the ladder sections or the like.

The first male spigot preferably includes an index plate having index steps set at 45° increments and a second index plate having index steps set at 30° increments and said index locking plate having three or four teeth or pins thereby providing articulated adjustment of said coupling in 15° increments.

The jaw operator most preferably includes a visual indicator of the locking status of the jaws.

### DETAILED DESCRIPTION OF THE INVENTION

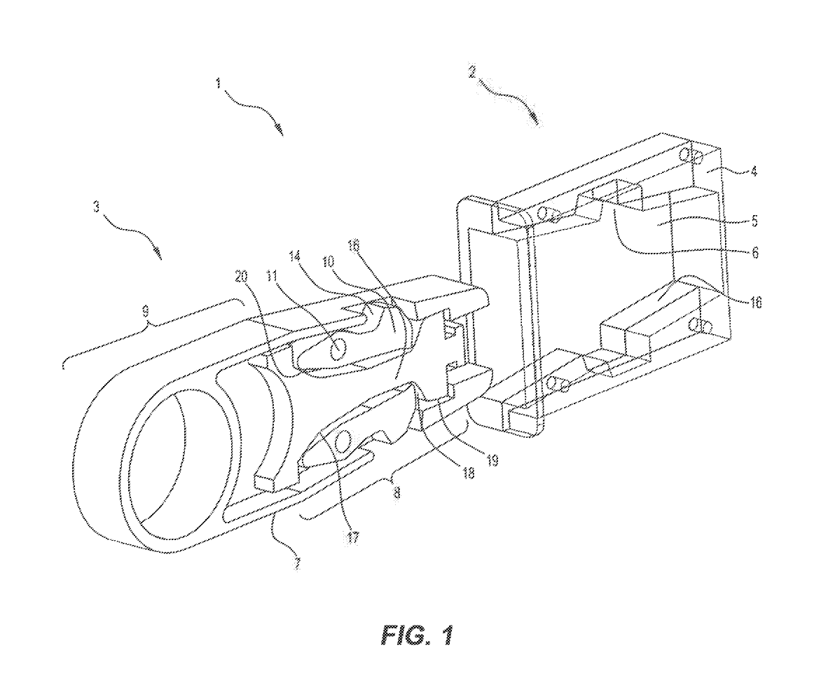

The invention will now be described with reference to particular embodiments as shown in FIGS. 1 to 12 and the accompanying legend.

FIG. 1 shows a phantom view of the coupling comprising a female socket and male spigot prior to engagement.

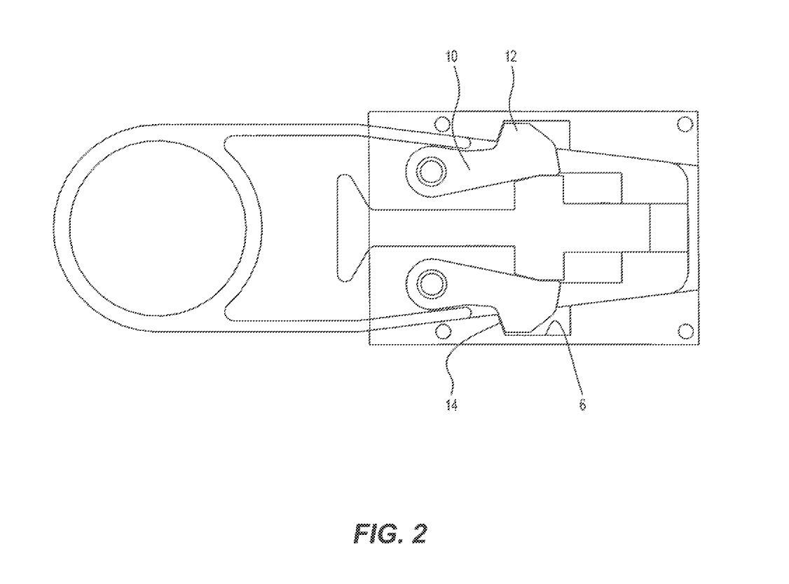

FIG. 2 shows a plan view of the engaged socket and spigot.

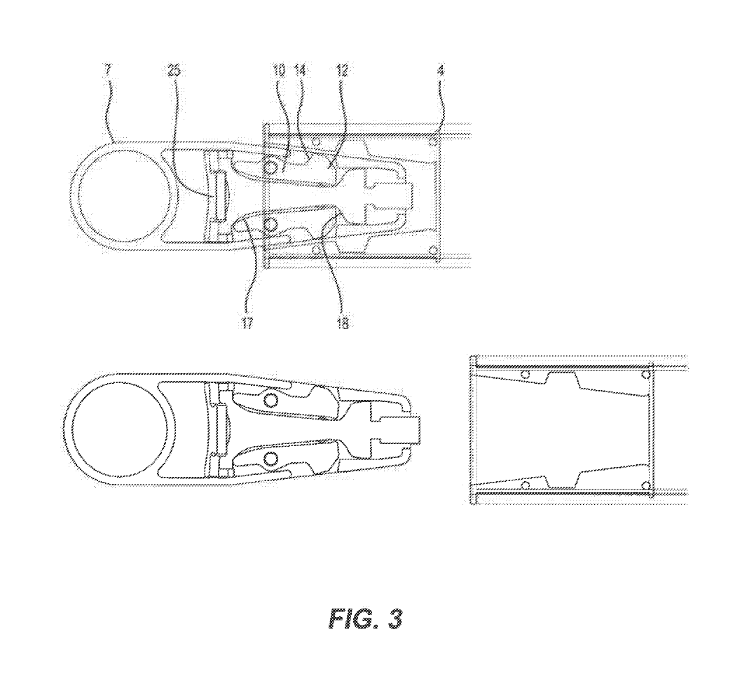

FIG. 3 shows an internal view of the coupling with the spigot having closed jaws in the first position.

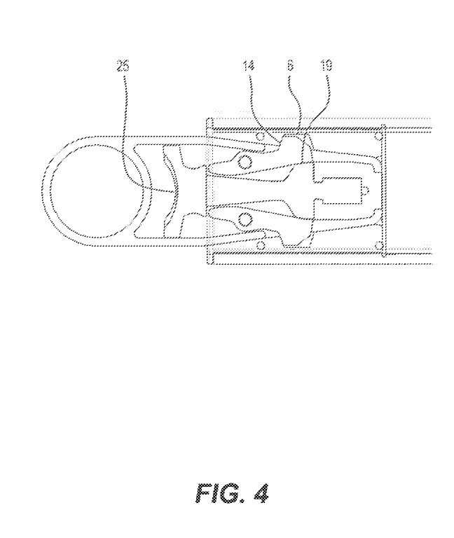

FIG. 4 shows an internal view of the coupling with the spigot having open jaws in the second position.

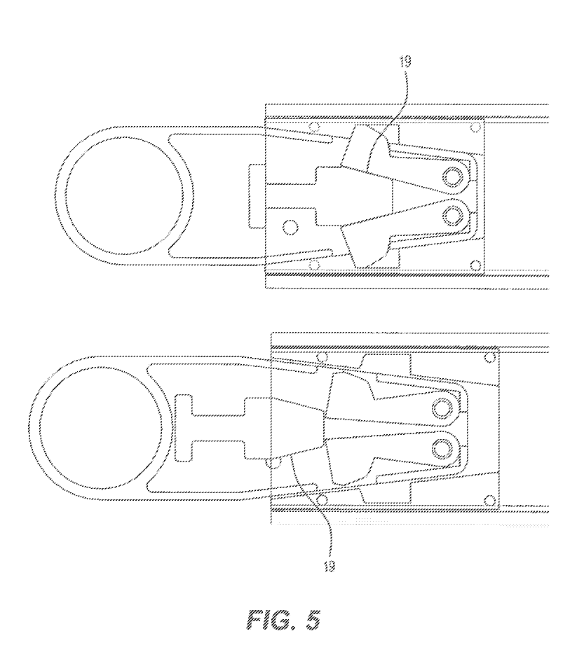

FIGS. 5 & 6 show alternative embodiment of a jaw locking mechanism.

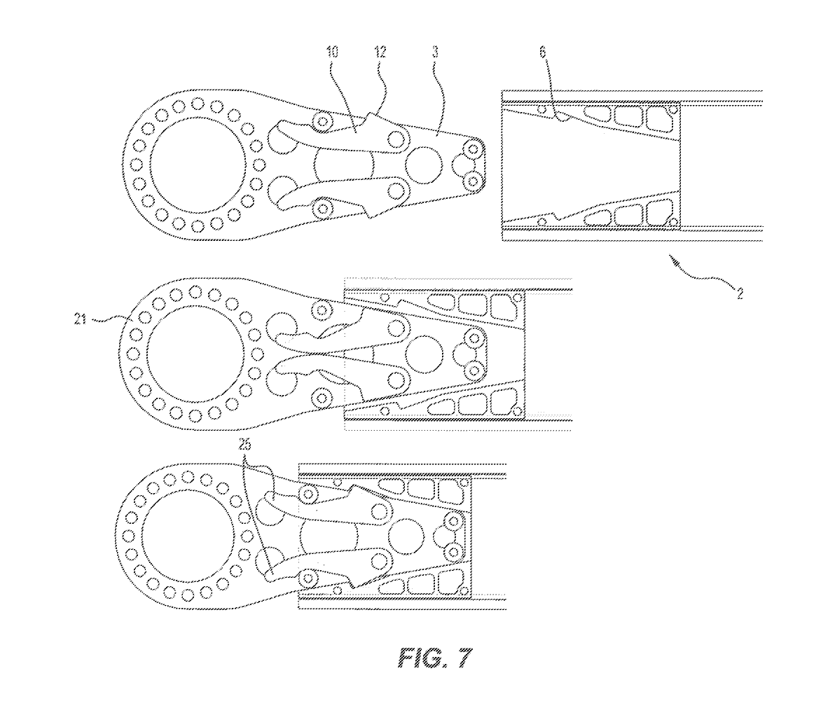

FIG. 7 shows an alternative embodiment of the coupling.

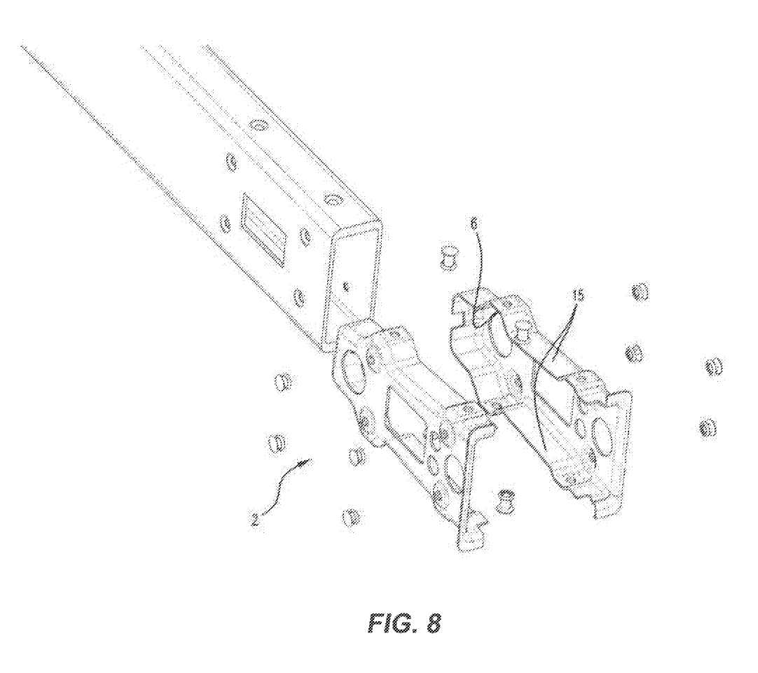

FIGS. 8 & 9 show a pressed metal fabrication of the coupling.

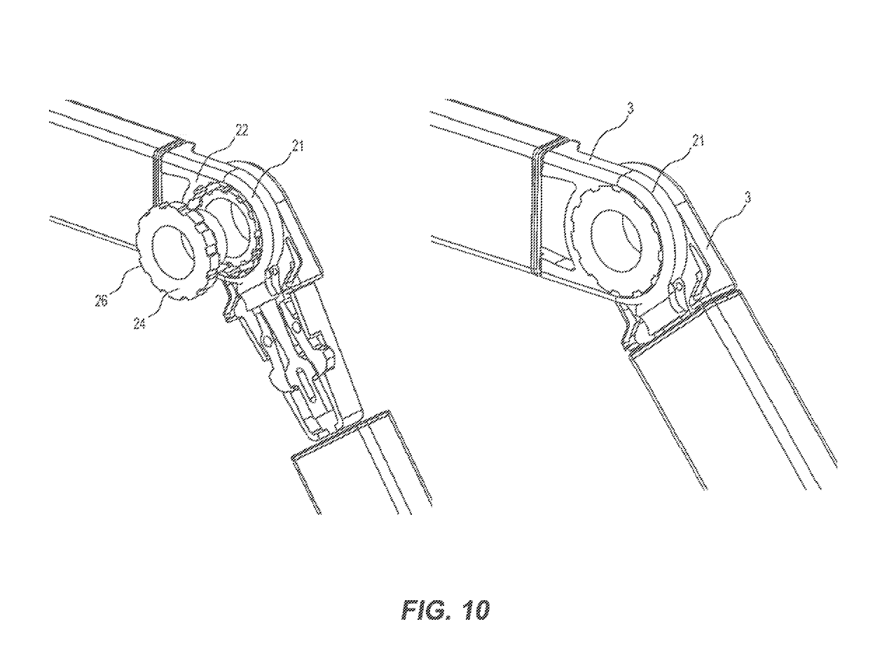

FIG. 10 shows one embodiment of an articulated coupling.

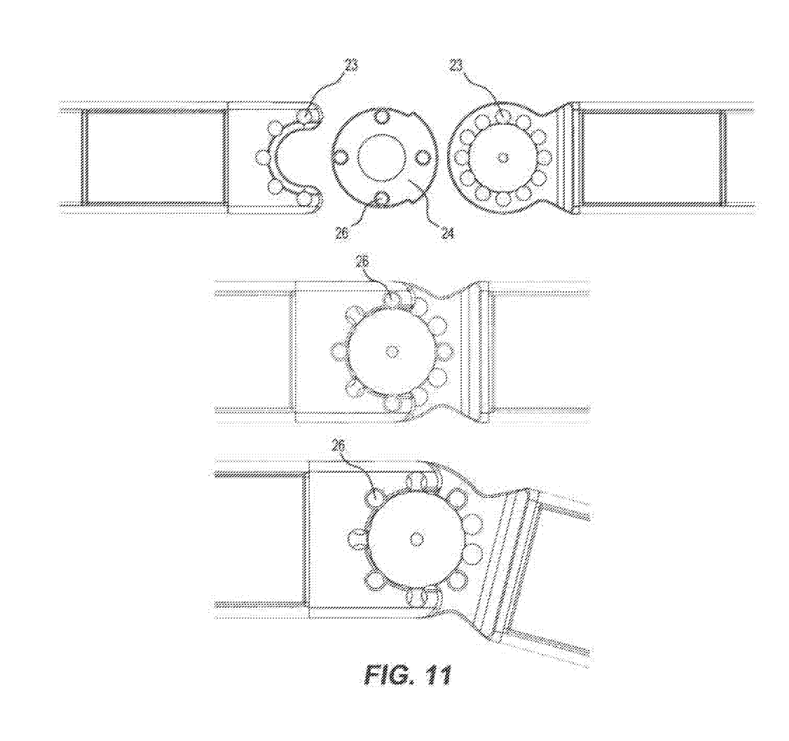

FIG. 11 shows an alternative embodiment of the articulated coupling.

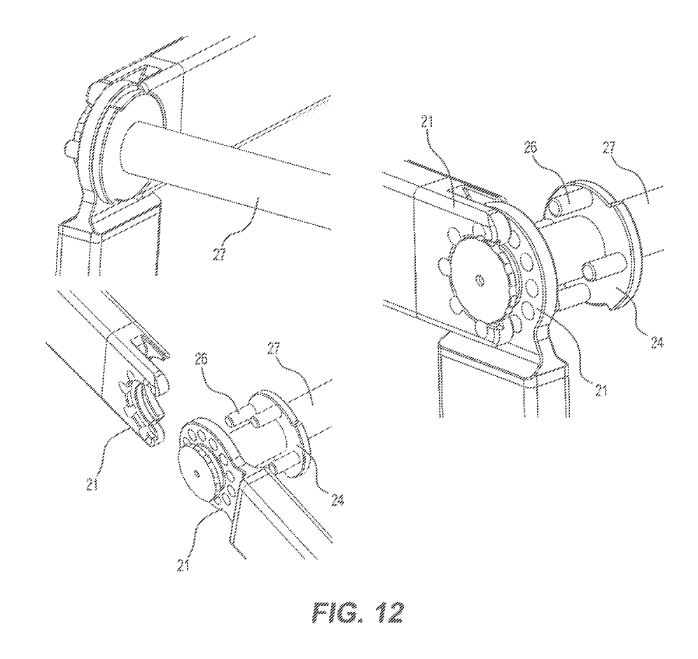

FIG. 12 shows the articulated coupling incorporating an axle of rotation.

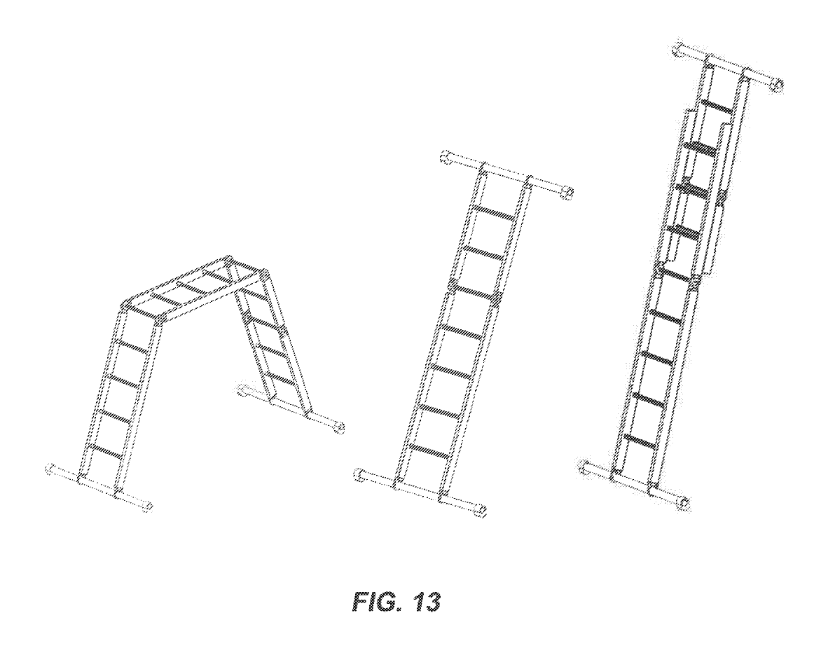

FIG. 13 shows various articulated configurations of a ladder using the coupling of the invention.

### LEGEND

1. Coupling

2. Female socket

3. Male spigot

4. Housing

5. Tapered dock

6. Intermediate step

7. Spigot body

8. Tapered reference portion

9. Section engaging articulation portion

10. Jaw

11. Pivot

12. Protruding lug

13. Biasing means

14. Angled face

15. Tapered dock side

16. Jaw operator

17. Jaw closing taper

18. Jaw opening taper

19. Jaw locking face

20. Leading taper

21. Indexed collar

22. Index steps

23. Index apertures

24. Index locking plate

25. Visual indicator

26. Teeth/pins

Referring firstly to FIGS. 1 to 4, the coupling 1 is made up of two key components being a female socket 2 which is formed in two parts and a male spigot 3 wherein the male spigot 3 and female socket 2 are both adapted to be fitted to respective ladder stiles either by gluing, rivoting, welding or other form of engagement to the open end of the respective stiles. Once the female socket 2 and male spigot 3 are suitably fitted to the end of the respective stiles, the socket and male spigot can thereby cooperate by corresponding engagement so as to effect a robust and reliable joint between the respective stiles which is free of all play, slop or looseness and provides a highly secure resultant join both in performance and feel.

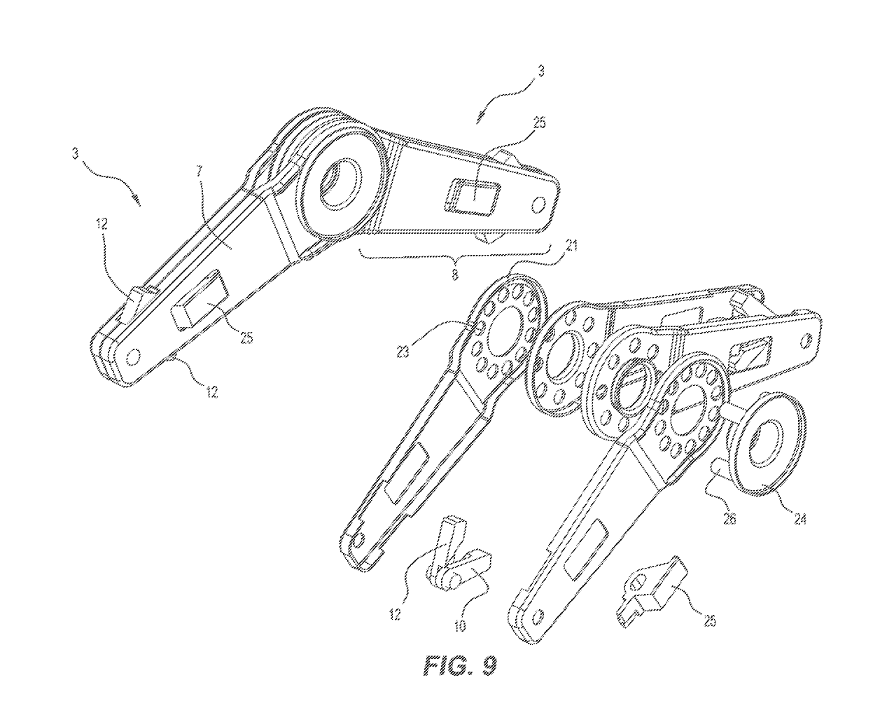

In a particularly preferred embodiment the female socket is adapted for integration with the stile of a ladder or the like and the male spigot free standing of the ladder stile either as a single unit shown in FIGS. 1 to 7 or a twin unit shown in FIGS. 9 and 10. In this manner, the moving parts of the coupling which are confined to the male spigot are located in readily removable parts of the coupling not integrated with the ladder stile and hence readily replaceable or available for maintenance in the event of mechanical failure or wear and tear.

The socket component 2 of the coupling comprises a housing 4 made up of two parts. The housing has an internal tapered dock 5 passing through the interior thereof with the tapered dock being formed as a continuous taper with the exception of an intermediate step 6 formed on the tapered side or sides thereof with the step 6 being adapted to form a keeper on each side of the tapered dock.

The corresponding spigot is made up of multiple parts including a spigot body 7 being made up of a tapered referencing portion 8 which is precisely configured and tapered to snugly engage the tapered dock 5 of the corresponding socket 2. The spigot body further comprises a section engaging portion 9 which is adapted to protrude from the socket once engagement of the spigot and socket is effected.

The spigot further includes two opposing jaws 10 pivotally connected at 11 to the body of the spigot within the referencing portion 8. Each of the jaws includes protruding lug 12 which is specifically configured to cooperate with the keeper 6. The two opposing jaws 10 are urged in an outward or open direction to actively engage said keeper by way of biasing means 13.

In order to ensure the snug and positive engagement of the spigot 1 to the socket 2 each of the lugs 12 of the respective jaws 10 include a rear facing angled face 14. The rear facing angled face 14 is particularly configured as shown in FIG. 2 to co-operate with the negative aspect of the step 6 being the inward tapering of the step sides such that the opening or splaying of the jaws causes the angled face to bear upon the negative aspect or tapered sides, in particular the tapered side of the step nearest to the opening of the socket, so as to draw the spigot into tight and snug engagement by ensuring the contiguous contact of the tapered reference portion of the spigot 8 with the tapered sides 15 of the tapered dock 5. The precise movement and engagement of the jaws to the tapered dock is assisted by pivoted attachment of the jaws to the spigot body.

As detailed in FIGS. 1 and 2 the dock preferably includes two symmetric tapered dock sides 15 which ensure the smooth and continuously aligned engagement of both the spigot and socket component of the coupling.

In order to effect the positive action of the jaws 10 the spigot preferably includes a jaw operator mechanism 16. The jaw operator is adapted to move longitudinally with the confines of the spigot body and includes a jaw closing taper 17 formed towards a first end of the jaw operator and a jaw opening taper 18 formed towards a second end with the jaw opening taper terminating in twin jaw locking faces 19. In this manner, the jaw operator can move from a first position with the jaw operator pushed towards the end of the spigot adapted for insertion into the socket whereby the jaw closing tapers act on leading tapers 20 formed in the jaws so as to pivot the jaws around the pivot 11 withdrawing or closing the jaws within the confines of the spigot body as shown in FIG. 1 thereby allowing ready and smooth insertion of the spigot into the socket. Once the spigot is fully inserted into the socket the jaw operator will return to the second position thereby ensure the jaws open by response to the jaw opening taper acting on the jaws 10 with the further movement of the jaw operator engaging the jaw locking faces to the jaws thereby locking the jaws in the splayed or open position so as to ensure lock engagement of the spigot to the socket.

The first position of the jaw operator is clearly shown in FIG. 3 with the jaws being withdrawn so as to ensure ready and complete insertion of the spigot into the socket. FIG. 4 shows the jaw operator in the second position being drawn back toward the rear of the spigot so as to cause the jaws to splay out into the open position thereby ensuring engagement with the socket. The biasing means is most preferably incorporated into the action of the jaw operator with the biasing means biasing the jaw operator for the second position thereby ensuring the bias is always toward the locked position for the jaws.

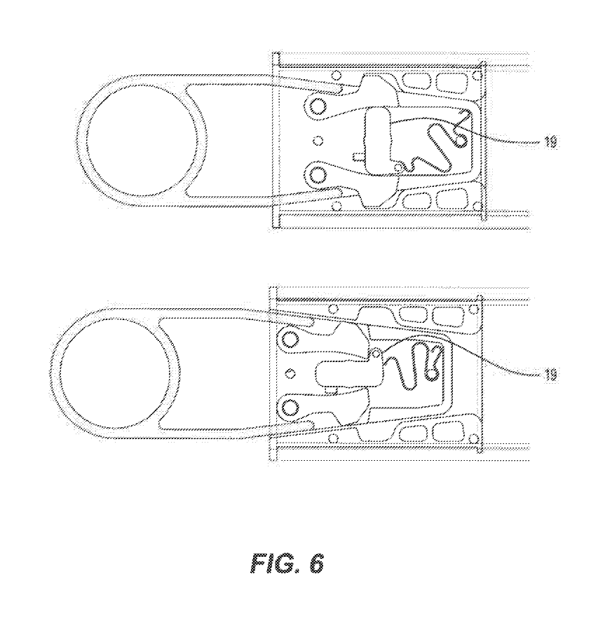

Referring now to FIGS. 5 and 6 an alternative embodiment of the invention is shown with an alternative jaw operator and a jaw locking system.

Referring now to FIG. 7 an alternative embodiment of the coupling is shown which functions without the use of a dedicated jaw operator and incorporates integral biasing of the jaws 10 toward the splayed or open position such that insertion of the spigot 3 into the socket 2 causes the lugs 12 of the jaws 10 to bear down upon the intermediate step 6 and return to the locked position once full engagement has occurred. The protruding ends of the jaws function as a visual indicator 25 to demonstrate that the spigot is fully engaged and locked into the socket.

FIGS. 8 and 9 detail one embodiment of the invention where the coupling is fabricated from pressed metal components. The pressed metal components are preferably formed in two parts of identical configuration allowing the socket as shown in FIG. 8 and the spigot as shown in FIG. 9 to be fabricated from a minimal number of components.

The coupling of the invention can be used to join straight components or at its most flexible can incorporate an indexed collar 21 as part of the section engaging portion of the male spigot as shown in FIGS. 9 to 12. In this manner, the indexed collar can incorporate a plurality of index steps or index apertures 23 formed around the periphery of the collar such that providing indexed collars on respective spigots allows two spigots to be joined together to form an articulated joint where the degree of rotation of the respective spigots can be locked into place with the use of an index locking plate 24. Referring to FIG. 11 a particularly preferred embodiment the invention is shown where the nature and flexibility of the articulated configuration of the joint can be maximised by providing a first male spigot having an open index collar with index steps set at 45° increments and a second closed index collar having index steps set at 30° increments such that the use of an index locking plate having three or four teeth or pins 26 set at 90 degrees allows the articulated form of the coupling to be adjustable over 15° increments.

Referring now to FIG. 12 the articulated configuration of the coupling can be further enhanced with the use of an axle 27 integrated with the index locking plate. The use of an axle in this manner of a wide range of configurations as shown in FIG. 13.

The coupling of the invention allows for the first time the ability to join together a large number of component parts to construct a ladder or other load bearing assembly with a secure, rigid and highly intuitive joining coupling. The coupling can incorporate a visual indicator 25 clearly showing the locked and secure nature of any assembly and the readiness for use as detailed in one embodiment given in FIG. 9.

In use, the coupling of the invention would have the socket component fitted to the end of a range of ladder sections of various length and a supply of spigots having a range of section engaging portions 9. The section engaging portions could include straight joiners having two tapered reference portions joined end to end and intended to join two ladder sections together as a single straight ladder; fixed angle joiners set at a given angle; articulated couplings made up of two spigots each having an index plate and a common index collar with the option of including an axle integrated with the locking plate. With this range of components and a selection of straight ladder sections and wide range of ladder assemblies could be constructed without the use of special tools or particular expertise whilst ensuring the construction of a rigid and highly stable assembly.

1-14. (canceled)

15. A coupling for joining together two sections of a ladder or the like, said coupling comprising a female socket and a male spigot adapted for fitting to said respective sections to be joined with the co-operation of said socket and said spigot effecting said joint wherein said socket includes a socket housing adapted for integration with the stile of said ladder and having an internal dock for receiving said spigot said dock including at least one tapered side, said tapered side including a negative step forming a keeper and wherein said spigot includes a spigot body having a tapered reference portion adapted to snugly engage said tapered dock and a section engaging portion protruding therefrom and one or a plurality of jaws pivoted to said spigot body at a fixed point said jaw or jaws including a protruding lug adapted to co-operate with said keeper and a biasing means adapted to expand open said jaws against said tapered dock to positively engage said protruding lug with said keeper.

16. A coupling according to claim 15, wherein said protruding lug includes an angled face configured to bear upon said negative step to bias said tapered reference portion of said spigot into snug continuous engagement with said internal dock of said female socket.

17. A coupling according to claim 15, wherein said dock includes two symmetric tapered dock sides with each dock side including a negative step.

18. A coupling according to claim 17, wherein said tapered reference portion of said spigot body includes symmetric tapered spigot sides.

19. A coupling according to claim 15, wherein said spigot includes a jaw operator having a jaw closing taper toward a first end, a jaw opening taper toward a second end and a jaw locking face said jaw operator being adapted for movement between a first position with said jaw closing taper acting on said jaws to close same and withdraw said jaws into said spigot body and a second position with said jaw opening taper acting on said jaws to open or expand same so as to project said lug outside said spigot body and said jaw locking face acting on said jaws to lack same on said open or expanded position.

20. A coupling according to claim 19, wherein said jaw operator includes said biasing means biasing said jaw operator to said second position.

21. A coupling accordingly to claim 19, wherein said jaws include a leading taper adapted to co-operate with said jaw opening taper of said jaw operator.

22. A coupling according to claim 15, wherein said male engaging portion includes an indexed collar.

23. A coupling accordingly to claim 22, wherein said indexed collar includes a plurality of peripheral index steps.

24. A coupling according to claim 23, wherein said index steps include apertures.

25. A coupling according to claim 22, further including an index locking plate.

26. A coupling according to claim 25, comprising a pair of male spigots co-operating with a single common index rocking plate to provide an articulated joint for said ladder sections.

27. A coupling according to claim 26, wherein a first male spigot includes an index plate having index steps set at 45° increments and a second index plate having index steps set at 30° increments and said index locking plate having 3 or 4 teeth or pins thereby providing articulated adjustments of said coupling in 15° increments.

28. A coupling according to claim 19, wherein said jaw operator includes a visual indicator of the locked status of said jaws.
